(19) United States
(12) Patent Application Publication
(10) Pub. No.: US 2009/0142962 A1
(43) Pub. Date: Jun. 4, 2009

(54) Electrical connector with improved contact arrangement

(75) Inventor: George(Huanyi) Zhang, Irvine, CA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD

(21) Appl. No.: 11/998,771

(22) Filed: Nov. 30, 2007

(51) Int. Cl. H01R 24/00

(52) U.S. Cl. 439/626

(57) ABSTRACT

An electrical connector (100) includes an insulative housing (2) defining a main portion (20) and a mating tongue portion (22) extending forwardly from the main portion, a number of signal contacts (31) arranged on the tongue portion, a number of ground contacts (32) arranged on the tongue portion alternatively with the signal contacts, and a pair of power contacts (33) arranged on the tongue portion to locate on the same level as that of the signal and ground contacts. The signal and ground contacts are arranged to locate between the pair of power contacts along said lateral direction.

### BACKGROUND OF THE INVENTION

1. Field of the Invention

The present invention generally relates to an electrical connector, and more particularly to an electrical connector used for high speed signal transmission and power transmission.

2. Description of Related Art

Serial ATA connectors in accordance with Serial ATA specification are widely used in desktops currently for transmitting signals from motherboard to HDD or transmitting power from power supply of the computer to the HDD, or transmitting signals or power between outer HDD to the computer. When the Serial ATA connectors used in external applications, current designs usually are single connector comprising signal and grounding contacts for signal transmission or single connector comprising power contacts for different-voltage power transmission. However, in some applications, the connector transmitting signals needs to be combined with power transmission. Thus, an additional power connector is no longer needed. The actual status is that there is no such a connector complying with such demands.

### BRIEF SUMMARY OF THE INVENTION

Accordingly, an object of the present invention is to provide an electrical connector with additional power contacts for multi-function.

In order to achieve the above-mentioned object, an electrical connector comprises an insulative housing defining a main portion and a mating tongue portion extending forwardly from the main portion, a plurality of signal contacts arranged on the tongue portion, a plurality of ground contacts arranged on the tongue portion alternatively with the signal contacts, and a pair of power contacts arranged on the tongue portion to locate on the same level as that of the signal and ground contacts. The signal and ground contacts are arranged to locate between the pair of power contacts along said lateral direction.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded, perspective view of an electrical connector in accordance with the present invention;

FIGS. 2-3 are views similar to FIG. 1, but viewed from different aspects;

FIGS. 4-5 are assembled, perspective views of FIGS. 1-2;

FIG. 6 is an assembled, perspective view of a plug connector; and

FIG. 7 is an exploded, perspective view of FIG. 6.

### DETAILED DESCRIPTION OF THE INVENTION

Reference will now be made to the drawing figures to describe the present invention in detail.

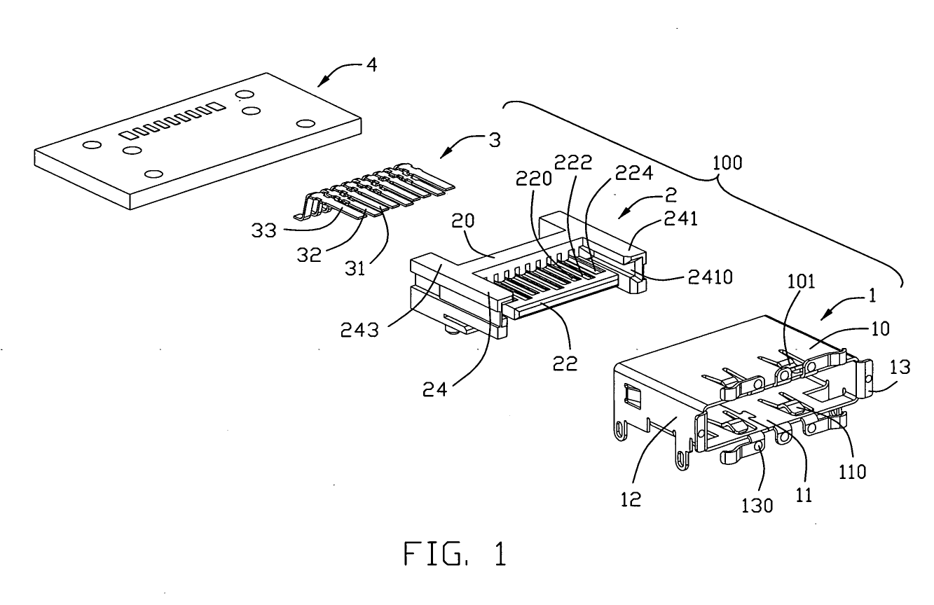

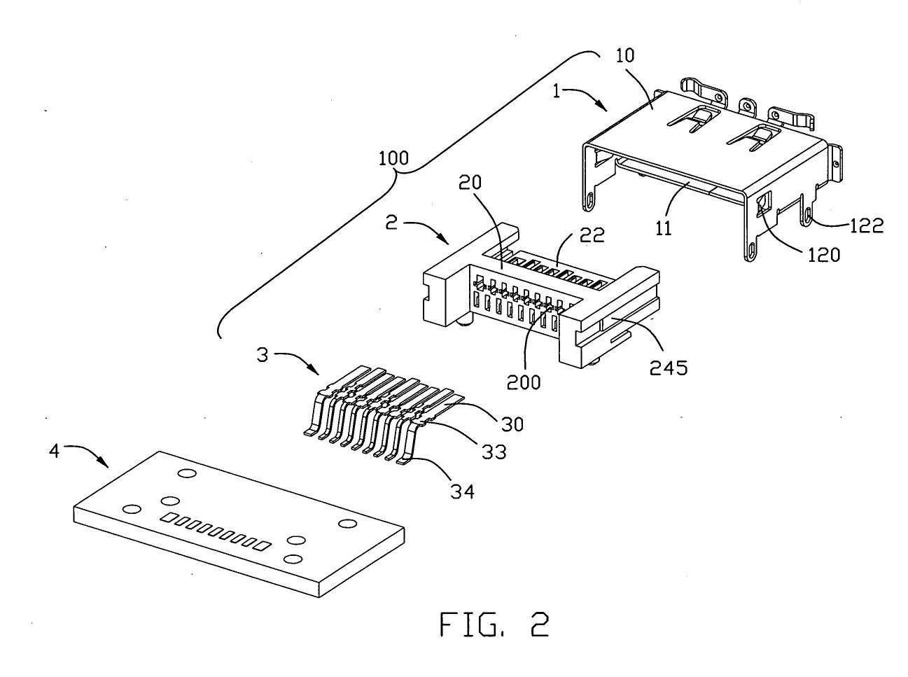

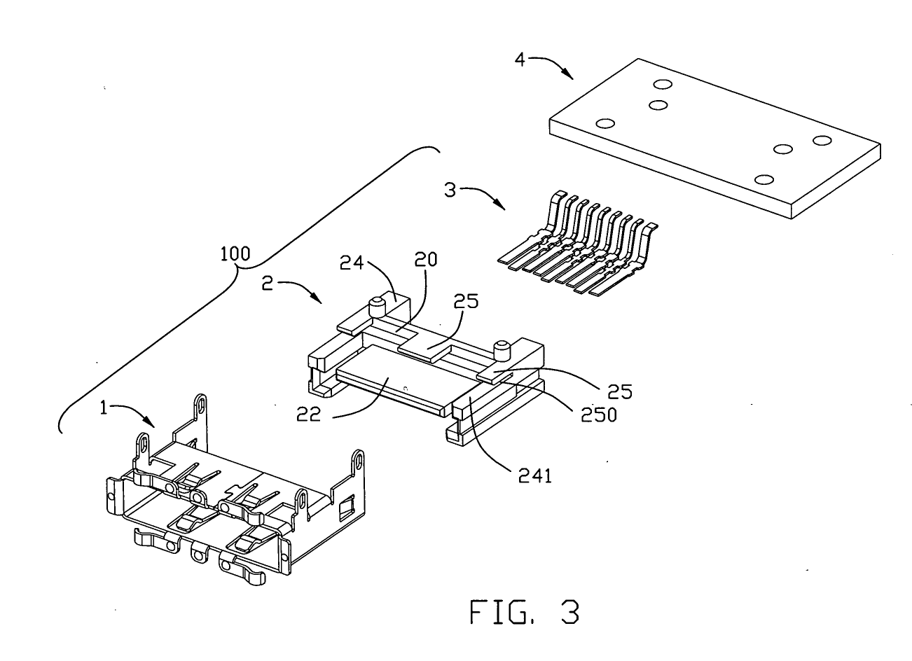

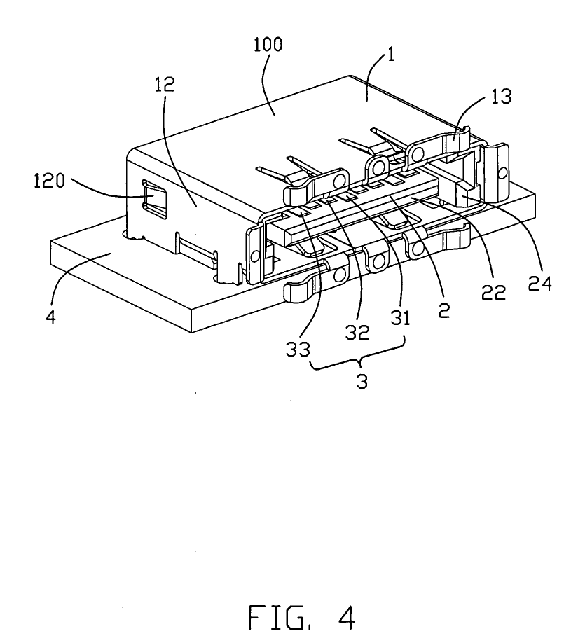

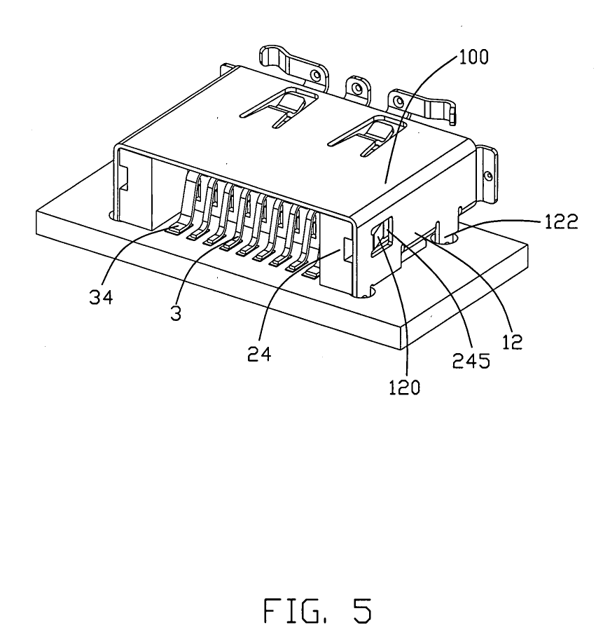

Referring to FIGS. 1-3 in conjunction with FIGS. 4-5, an electrical connector 100 in accordance with the present invention comprises an insulative housing 2, a plurality of contacts 3 received in the insulative housing 2 and a conductive shell 1 enclosing the insulative housing 2 and the contacts 3.

The insulative housing 2 of the electrical connector 100 comprises a main portion 20, a tongue portion 22 extending forwardly from the main portion 20, and a pair of side portions 24 connecting with opposite ends of the main portion 20 and located at opposite sides of the tongue portion 22. Each side portion 24 has a U-shape first section 241, served as a guiding section, extending beyond the front surface of the main portion 20 to locate at opposite sides of the tongue portion 22, a middle section 243 connecting with the main portion 20, and a second section 242 extending beyond the rear surface of the main portion 20. Each first section 241 defines a guiding slot 2410 for guiding insertion of a plug connector (not shown) and aligning with the tongue portion 22 along transverse direction. A plurality of passageways 200 are defined through the main portion 20. The tongue portion 22 defines a plurality of first receiving channels 220, a plurality of second receiving channels 222 longer than the first receiving channels 220 and alternatively arranged with the first receiving channels 220, and a pair of third receiving channels 224 shorter than the second receiving channels 222 and located at opposite outermost sides. A slot 245 is recessed inwardly from outer periphery of each side portion 24 with different depths in different sections of the side portion 24. A pair of tubers 25 respectively extend forwardly from opposite lower edges of the middle sections 243 to form a pair of gaps 250 between the tubers 25 and the lower surfaces of the first sections 241. A middle tuber 25 extends forwardly from middle lower edge of the main portion 20 to locate below the tongue portion 22.

The contacts 3 consist of a plurality of first contacts 31 forming two pairs of different pairs and served as signal contacts for signal transmission, a plurality of second contacts 32 alternatively arranged with the differential pairs and served as ground contacts for ensuring signal transmission, and a pair of third contacts 33 served as power contacts for power transmission and located at outermost sides of the contact array. The ground contact 32 is longer than the signal and power contacts 31, 33 for hot-pluggable, while the power contact 33 is wider than the signal and ground contacts 31, 32 for handling more currents. Each contact 31, 32, 33 comprises a mating section 30, an interferential section 33 extending from the mating section 30 with barbs formed on opposite lateral edges, and a soldering section 34 bending downwardly and slantly then flatly from the interferential section 33 for being surface-mounted to a printed circuit board 4.

When the contacts 3 are assembled to the second housing 2, the contacts 3 respectively protrude through the passageways 200 with the mating sections 30 respectively located in the first, second and third receiving channels 220, 222, 224 and the interferential sections 33 interferentially engaging with the passageways 200 for retaining the contacts 3 in the second housing 2. After assembly, the grounding pieces of the first contacts 31 are located closer to the front edge of the tongue portion 22 than the signal and power contacts 31, 33 for reliable signal transmission.

The conductive shell 1 is U-shape and comprises a top wall 10, a bottom wall 11 opposite to the top wall 10, and a pair of lateral walls 12 extending downwardly from the top wall 10. The top wall 10 forms a pair of first spring fingers 101. The bottom wall 11 forms a pair of second spring fingers 110 corresponding to the first spring fingers 101 and the rear edge thereof is inserted into the gaps 250 of the insulative housing 2 to be sandwiched by the tabs 25 and lower edges of the first sections 241 of the side portions 24 and the main portion 20. Each lateral wall 12 forms a pressing tab 120 locking into the slot 245 for securing the conductive shell 1 to the insulative housing 2. Each lateral wall 12 forms a pair of legs 122 for positioning the conductive shell 1 to the printed circuit board 4. A plurality of spring tabs 13 are formed with the front edges of the walls 10, 11, 12 and bend vertically and outwardly from the edges. Each spring tab 13 is formed with a bump 130 for increasing the spring force when abutting against a panel to which the electrical connector 100 is mounted.

Since the soldering sections 34 of the contacts 3 are located between the second sections 242 of the insulative housing 2, and front and rear edges of the conductive shell 1 are respectively flush with front and rear edges of the first and second sections 241, 242. The insulative housing 2 and the contacts 3 are all fully shielded by the conductive shell 1. Therefore, safe signal and power transmission is achieved. In addition, the one row arrangement of the contacts 3 increases the lateral dimension of the tongue portion 22.

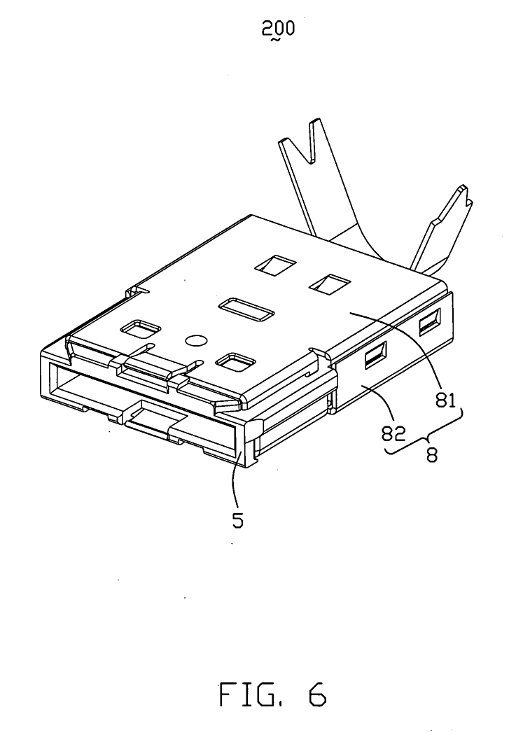

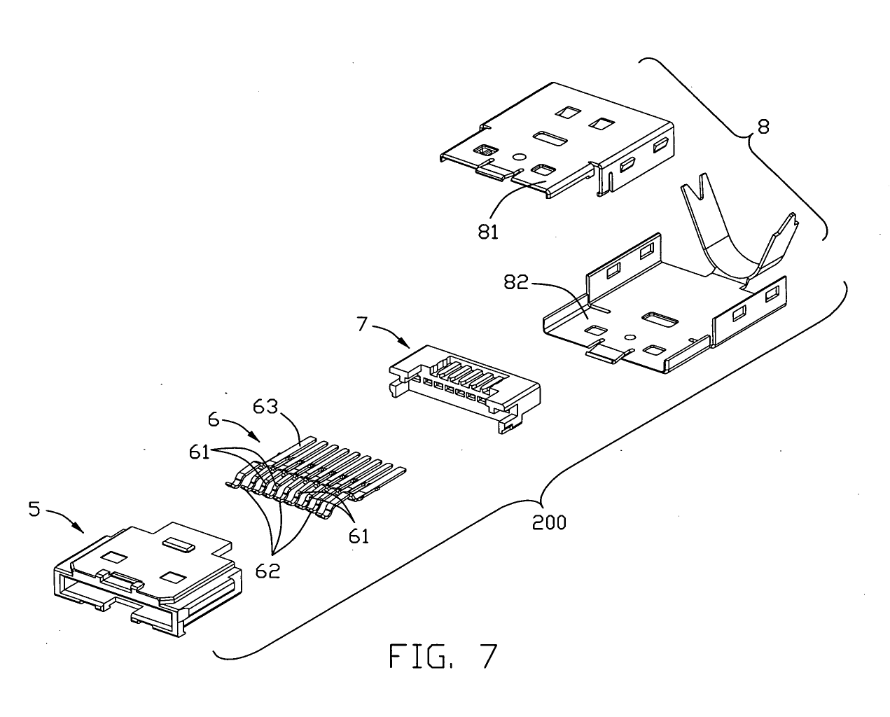

Please refer to FIGS. 6-7, a plug connector 200 capable of mating with the electrical connector 100 are shown. The plug connector 200 comprises a dielectric housing 5, a plurality of terminals 6 accommodated in the dielectric housing 5, a spacer 7 assembled to the dielectric housing 5 and defining a plurality of channels aligning tail portions of the terminals 6, a conductive shield 8 including a top shield half 81 and a lower shield half 82 assembled with the top shield half 81 to enclose the dielectric housing 5 and the terminals 6, and a cable electrically soldered with the tail portions of the terminals 6.

Please refer to FIG. 4, the terminals 6 are arranged in a contact array and comprise two pairs of signal terminals 61 served as differential pairs, three ground terminals 62 with two located at outer sides of the signal terminals 61 and one located between the two pairs of signal terminals 61, and a pair of power terminals 63 located at outermost sides of the contact array with the signal and ground terminals 61, 62 located therebetween. The width of each power terminals 63 is wider than that of each of the signal and ground terminals 61, 62, while, the signal and ground terminals 61, 62 have the same structure as each other. The signal, ground, and power terminals 61, 62, 62 respectively electrically contact the signal, ground and power contacts 31, 32, 33.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1-19. (canceled)

20. An electrical connector comprising:
an insulative housing including a mating tongue exposed in a mating Dort and defining a mating direction thereof: and
three type contacts including:
two power contacts being on two opposite side regions of the mating tongue:
three ground contacts located between said two power contacts in a transverse direction perpendicular to said mating direction:
two pairs of signal contacts, each pair being located between the corresponding two adjacent ground contacts in said transverse direction: wherein
said signal contacts, said ground contacts and said power contacts are disposed on a same face of the mating tongue under a condition that the power contacts are widest among said three type contacts while the ground contacts are longest among said three type contacts;
wherein said three types contacts are symmetrically arranged with one another with regard to a middle ground contact.
